(19) United States
(12) Patent Application Publication
(10) Pub. No.: US 2018/0306513 A1
(43) Pub. Date: Oct. 25, 2018

(54) ENERGY-SAVING CHARGE TRANSPORT SYSTEM IN THE PRESS-FURNACE LINE

(71) Applicant: POLITECHNIKA KRAKOWSKA IM. TADEUSZA KOSCIUSZKI, KRAKOW (PL)

(72) Inventors: RYSZARD MOSZUMANSKI, KRAKOW (PL); SLAWOMIR KNAPIK, WOLA FILIPOWSKA (PL); JERZY KRYZA, KRAKOW (PL); ADAM TABOR, KRAKOW (PL)

(21) Appl. No.: 15/912,830

(22) Filed: Mar. 6, 2018

Related U.S. Application Data
(63) Continuation-in-part of application No. 14/465,391, filed on Aug. 21, 2014, now abandoned.

(30) Foreign Application Priority Data
Dec. 23, 2013 (PL) P.406640

(51) Int. Cl. F27D 17/00; F27B 9/24; F27B 9/38

(52) U.S. Cl. CPC F27D 17/004; F27D 2003/0065; F27B 9/38; F27B 9/24

(57) ABSTRACT

An energy-saving charge transport system in a press-furnace line, for articles to be baked from the press to the furnace and for articles baked to a finished product storage area, having two levels of a heat tunnel, wherein articles to be baked are arranged on empty transport pallets in two trains of the press, two heat recovery tunnels, the right heat recovery tunnel and the left heat recovery tunnel are situated under the furnace and outside said furnace, the furnace comprises inside two on the contrary movable tracks for articles to be baked, each of the heat recovery tunnel having a down level for baked articles and an upper level for raw articles, said baked and raw articles moveably on the contrary directions, said levels arranged respectively with the right train of the press and the left train of the press, a first actuator cyclically pushes the pallets with the product to be baked arranged in the first train and delivers the pallets onto the upper level of the first heat recovery tunnel, the transport pallets with the raw charge are delivered, one after the other, to a first elevator, that delivers the pallets with the raw charge onto a level of left-hand furnace track.

The subject of the present invention is an energy-saving charge transport system in a press-furnace line with recovery of heat energy. Commonly known and applied systems for transporting charge between the press and the furnace, where transport of the charge within the furnace area is connected with the need to position transport pallets carrying the charge before introducing them into furnace and receive transport pallets with charge after thermal treatment, require the use of long transport trains in view of large dimensions of typical tunnel furnace and feeding devices. They require also cooling the processed charge (after thermal treatment) down to the ambient temperature before introducing the finished product to the warehousing area.

The raw charge needs to be heated from the ambient temperature, and the processes charge after completion of the heat treatment cycle must be cooled down to ambient temperature before introducing to the warehousing area. The heat energy released from such cooled charge is irretrievably and entirely lost.

The objective of the invention consists in introducing a rational management of heat energy in the charge transport system along the press-furnace route and in the area surrounding the furnace and by means of a well-thought-out arrangement of transport routes and charging elevators, achieving compact dimensions of the whole transport structure.

The essence of the energy-saving charge transport system in the press-furnace line consists in that the articles to be baked are arranged on empty transport pallets in two trains of the press, two heat recovery tunnels, the right heat recovery tunnel and the left heat recovery tunnel are situated under the furnace and outside said furnace, the furnace comprises inside two on the contrary movable tracks for articles to be baked.

Each of the heat recovery tunnel having a down level for baked articles and an upper level for raw articles, said baked and raw articles moveably on the contrary directions, said levels arranged respectively with the right train of the press and the left train of the press.

A first actuator cyclically pushes the pallets with the product to be baked arranged in the first train and delivers the pallets onto the upper level of the first heat recovery tunnel, the transport pallets with the raw charge are delivered, one after the other, to a first elevator, that delivers the pallets with the raw charge onto a level of left-hand furnace track, after which the actuator positions them in a furnace on left-hand track, and after covering the whole length of the left track and after baking them, the pallets with the baked charge are delivered to the second elevator, and the second elevator transports the pallets with the baked charge onto a lower level of a second heat recovery tunnel, the actuator positions the pallet with the baked charge along the second heat recovery tunnel, and further the actuator moves the pallets with the baked charge along the second heat recovery tunnel under the raw charge moved in contrary direction in an upper level of this second heat recovery tunnel, as far as to the pallet unloading station, while in the pallet unloading station, a finished product is taken off the pallets and directed to a finished product storage area after which the empty transport pallets are returned to a press.

Simultaneously the actuator cyclically pushes the pallets with the product to be baked arranged in the second train and delivers the pallets onto an upper level of a second heat recovery tunnel, the transport pallets with the raw charge are delivered, one after another, to the second elevator that delivers the pallets with the raw charge onto a level of right-hand furnace track, after which the actuator positions them on the right-hand track, after covering the whole length of the right track and after baking them, the pallets with the baked charge are delivered to the first elevator that transports the pallets with the baked charge onto the lower level of the first heat recovery tunnel, the actuator positions the pallets with the baked charge along the first heat recovery tunnel and the actuator moves the pallets with the baked charge along the first heat recovery tunnel under the raw charge moved in contrary direction in an upper level of this first heat recovery tunnel, as far as to a pallet unloading station where a finished product is taken off the pallets and directed to a finished product storage area, while empty transport pallets are returned to a press.

The merit of the present invention consists in that the transport system manages the energy in a rational way in all areas of operation. The waste heat coming from the charge already baked is taken over and reused. The heat is used for a preliminary heating the raw charge. Simultaneously with the preliminary heating of the raw charge, the process occurs of a preliminary cooling of the finished product that is further directed to the finished product storage area. Electric drives of transport elevators operate in a system allowing to recover electric energy from braking.

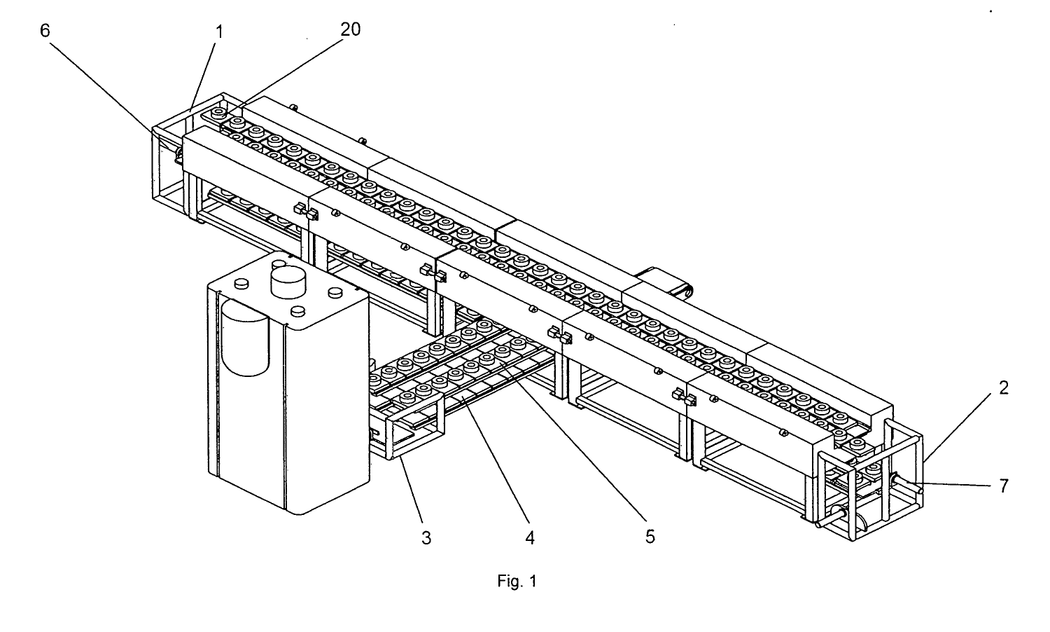

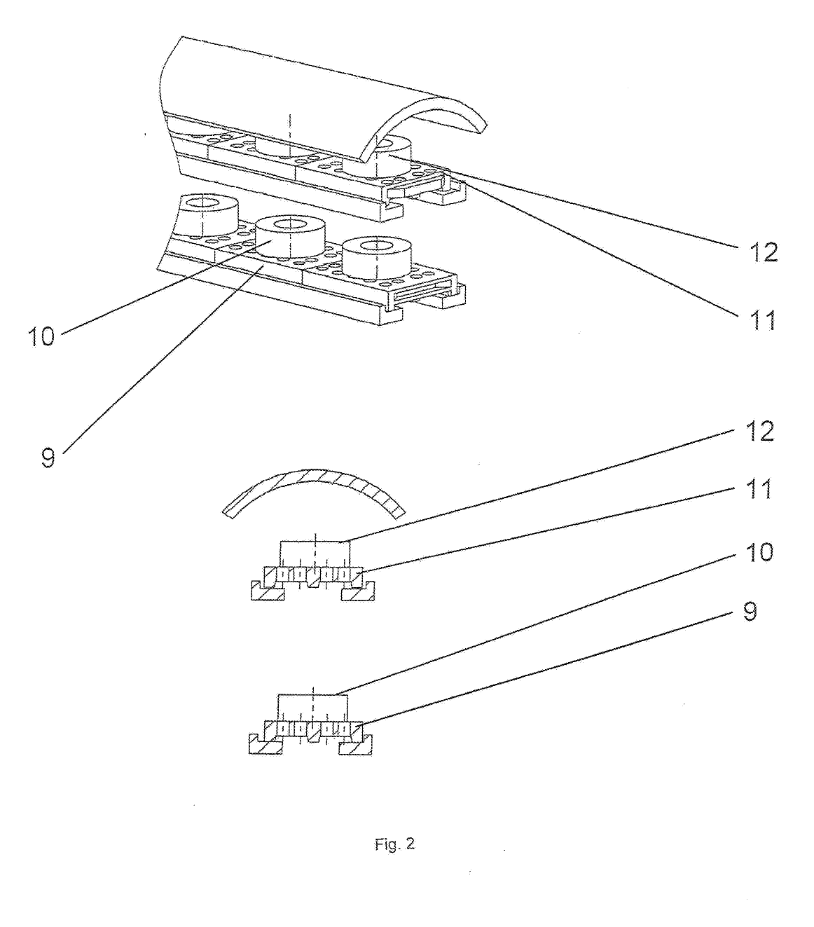

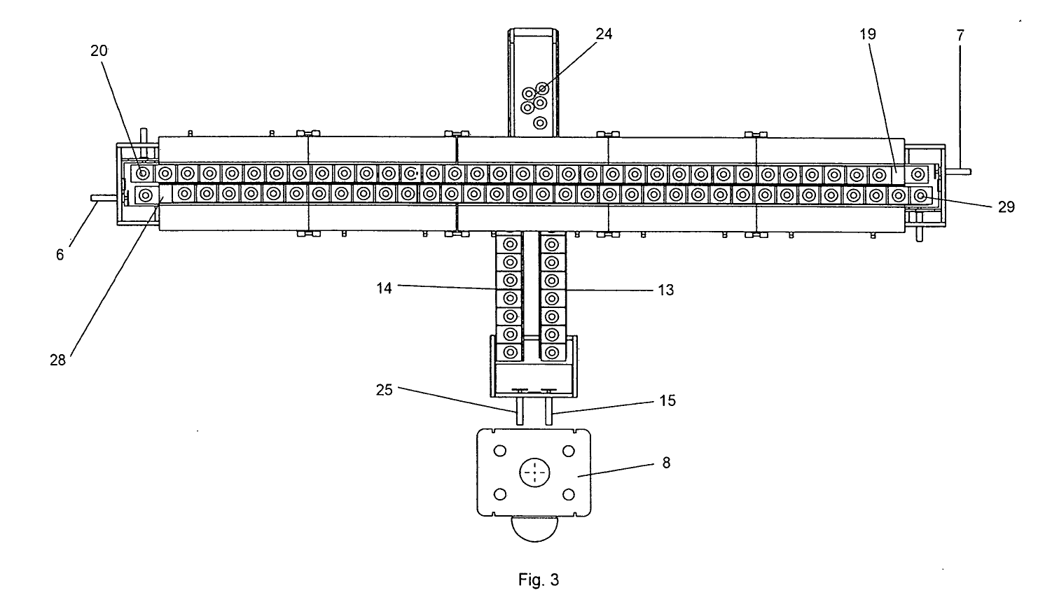

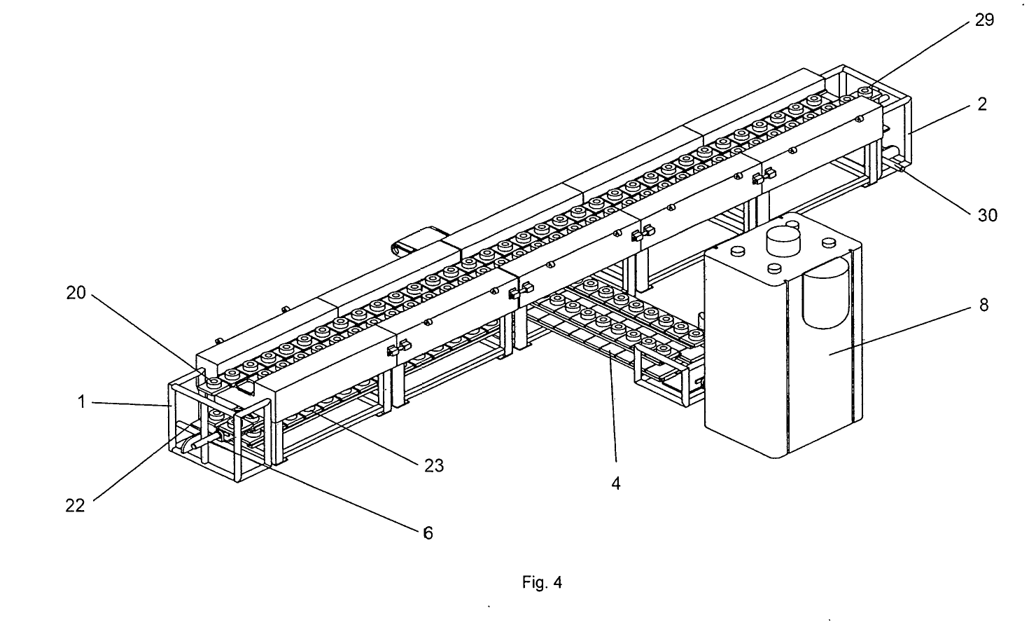

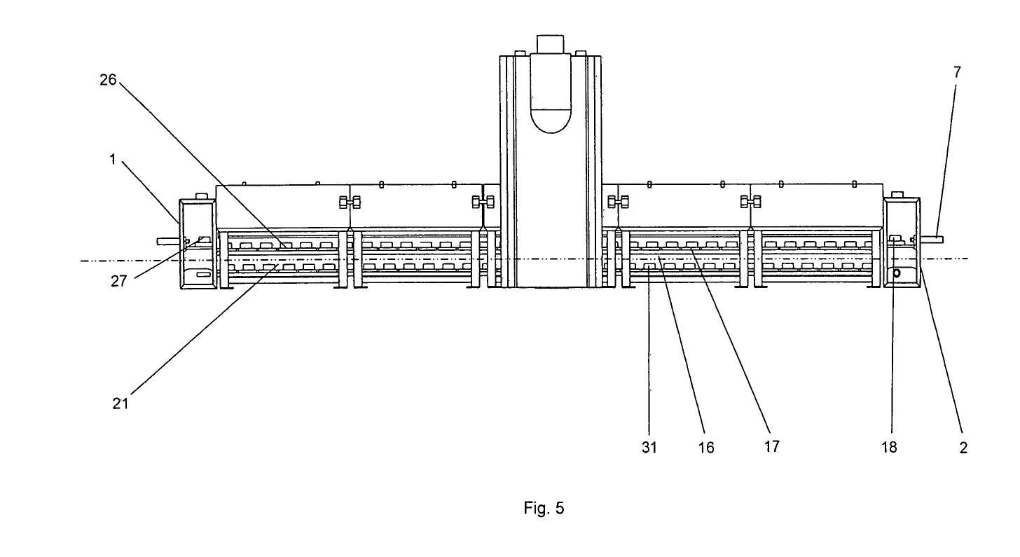

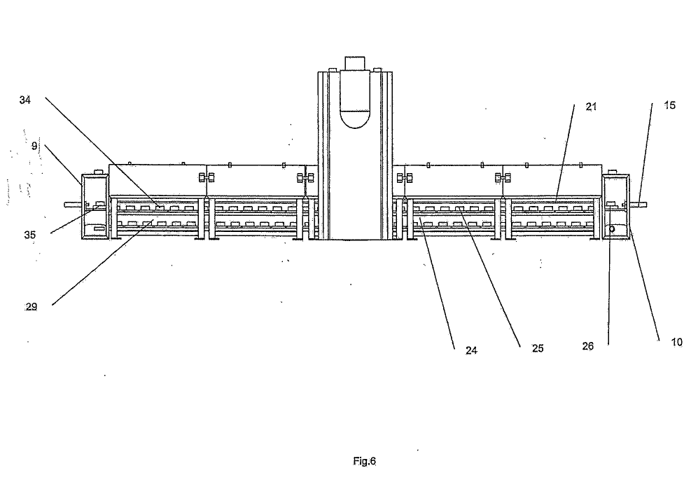

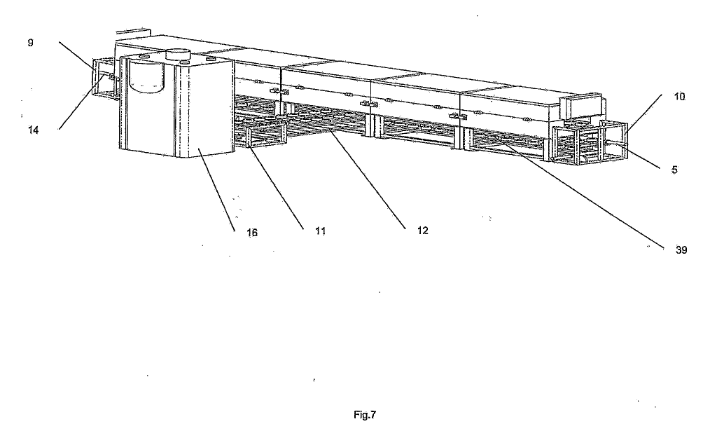

The invention is illustrated by means of examples of embodiments shown in FIG. 1, FIG. 2, FIG. 3, FIG. 4, and FIG. 5.

FIG. 1 shows embodiment of the present invention implemented in a tunnel backward-motion push furnace

FIG. 2 shows the principle of operation of the heat recovery tunnel

FIG. 3 shows embodiment of the present invention implemented in a tunnel backward-motion push furnace

FIG. 4 shows embodiment of the present invention implemented in a tunnel backward-motion push furnace

FIG. 5 shows embodiment of the present invention implemented in a tunnel backward-motion push furnace.

Articles to be baked are arranged on empty transport pallets 4 in two trains 13, 14 of the press. Two heat recovery tunnels, the right heat recovery tunnel and the left heat recovery tunnel are situated under the furnace and outside said furnace, the furnace comprises inside two on the contrary movable tracks 19, 28 for articles to be baked.

In the example embodiment of the present invention implemented in a tunnel backward-motion push furnace presented in FIG. 1, FIG. 3, FIG. 4 and FIG. 5 three transport elevator units are employed: first elevator 1 on the left-hand-side of the furnace equipped with actuator 6 activating the pushing cycle of the right-hand track; second elevator 2 on the right-hand-side of the furnace equipped with the actuator 7 activating the pushing cycle of the left-hand track; and third elevator 3 delivering empty transport pallets 4 to a press 8 and receiving pallets with articles 5 to be baked.

The principle of operation of the heat recovery tunnel is presented in FIG. 2 The transport pallet 9 provided with openings carries the baked charge 10. The transport pallet 11 with openings is loaded with the raw charge 12. Heated air flows upwards and heats up the row charge 12. Articles to be baked are arranged on empty transport pallets 4 in two trains—first train 13 and second train 14. The actuator 15 cyclically pushes pallets loaded with the article to be baked located in the first train 13 and supplies them onto the upper level of a first heat recovery tunnel 16, whereas transport pallets with the row charge 17 are supplied, one after another, to the second elevator 2. The elevator 2 delivers the transport pallets with the raw charge 18 onto the left-hand furnace train level, and then the actuator 7 places them in the furnace on the left-hand track 19. After covering the whole length of the left-hand track 19 and after baking, the pallets with the baked charge 20 are delivered to the first elevator 1. The first elevator 1 transports the pallets with the baked charge 20 onto the lower level of a second heat recovery tunnel 21; next, actuator 22 positions the pallets with the baked charge 23 along the second heat recovery tunnel 21, and finally the actuator 6 moves the pallets with the baked charge 23 along the second heat recovery tunnel 21 right to the pallet unloading station.

In the pallet unloading station, finished product is taken off the pallets and delivered to the finished product storage area 24, whereas empty transport pallets 4 come back to the press 8.

The actuator 25 cyclically pushes pallets with the product to be baked arranged in the second train 14 and delivers them onto the upper level of the second heat recovery tunnel 21, the pallets with the raw charge 26 are delivered, one after another, to the first elevator 1, and the first elevator 1 delivers the pallets with the raw charge 27 onto the right-hand furnace track level, after which the actuator 6 locates them on the right-hand furnace track 28. After covering the whole length of the right-hand track 28 and after baking, the pallets with the baked charge 29 are delivered to the second elevator 2. The second elevator 2 delivers the pallets with said baked charge 29 onto the lower level of the first heat recovery tunnel 16. Next, the actuator 22 positions the pallets with said baked charge along the first heat recovery tunnel 16, and the actuator 7 moves pallets with the baked charge 31 along the first heat recovery tunnel 16 as far as to the pallet unloading station. In the pallet unloading station, the finished product is taken off the pallets and directed to the finished product storage area 24, while empty transport pallets 4 are returned to the press 8.

1. An energy-saving charge transport system in a press-furnace line, for articles to be baked from the press to the furnace and for articles baked to a finished product storage area, having two levels of a heat tunnel, wherein
articles to be baked are arranged on empty transport pallets in two trains of the press, two heat recovery tunnels, the right heat recovery tunnel and the left heat recovery tunnel are situated under the furnace and outside said furnace, the furnace comprises inside two on the contrary movable tracks for articles to be baked,
each of the heat recovery tunnel having a down level for baked articles and an upper level for raw articles, said baked and raw articles moveably on the contrary directions, said levels arranged respectively with the right train of the press and the left train of the press,
a first actuator cyclically pushes the pallets with the product to be baked arranged in the first train and delivers the pallets onto the upper level of the first heat recovery tunnel, the transport pallets with the raw charge are delivered, one after the other, to a first elevator, that delivers the pallets with the raw charge onto a level of left-hand furnace track, after which the actuator positions them in a furnace on left-hand track, and after covering the whole length of the left track and after baking them, the pallets with the baked charge are delivered to the second elevator, and the second elevator transports the pallets with the baked charge onto a lower level of a second heat recovery tunnel, the actuator positions the pallet with the baked charge along the second heat recovery tunnel, and further the actuator moves the pallets with the baked charge along the second heat recovery tunnel under the raw charge moved in contrary direction in an upper level of this second heat recovery tunnel, as far as to the pallet unloading station, while in the pallet unloading station, a finished product is taken off the pallets and directed to a finished product storage area after which the empty transport pallets are returned to a press,
simultaneously the actuator cyclically pushes the pallets with the product to be baked arranged in the second train and delivers the pallets onto an upper level of a second heat recovery tunnel, the transport pallets with the raw charge are delivered, one after another, to the second elevator that delivers the pallets with the raw charge onto a level of right-hand furnace track, after which the actuator positions them on the right-hand track, after covering the whole length of the right track and after baking them, the pallets with the baked charge are delivered to the first elevator that transports the pallets with the baked charge onto the lower level of the first heat recovery tunnel, the actuator positions the pallets with the baked charge along the first heat recovery tunnel and the actuator moves the pallets with the baked charge along the first heat recovery tunnel under the raw charge moved in contrary direction in an upper level of this first heat recovery tunnel, as far as to a pallet unloading station where a finished product is taken off the pallets and directed to a finished product storage area, while empty transport pallets are returned to a press.
